(19) United States
(12) Patent Application Publication
(10) Pub. No.: US 2006/0215310 A1
(43) Pub. Date: Sep. 28, 2006

(54) Systems and methods for encoding identifying information on a surface of a rotatable medium

(75) Inventor: Fernando A. Zayas, Loveland, CO (US)

Correspondence Address: FLIESLER MEYER, LLP, FOUR EMBARCADERO CENTER, SUITE 400, SAN FRANCISCO, CA, 94111, US

(73) Assignee: Matsushita Electric Industrial Co., Ltd., Kadoma-shi (JP)

(21) Appl. No.: 11/090,428

(22) Filed: Mar. 25, 2005

(51) Int. Cl. G11B 5/596; G11B 5/09

(52) U.S. Cl. 360/77.08; 360/48

(57) ABSTRACT

Systems and methods in accordance with embodiments of the present invention can be applied to encode non-servo information on a rotatable medium connected with a data storage device. For example, such information can describe the data storage device and can include a serial number, component information, manufacturing date, etc. The non-servo information can comprise at least one burst within a servo burst pattern. In an embodiment, the at least one burst can be positioned in a portion of the burst pattern preceding a track where user data is not intended to be stored. In other embodiments, each burst from the servo burst pattern can be demodulated as two bursts, one of which can include non-servo information.

### FIELD OF THE INVENTION

The present invention relates to data storage devices, and servo patterns for positioning heads over media in the data storage devices.

### BACKGROUND

Advances in data storage technology have provided for ever-increasing storage capability in devices such as DVD-ROMs, optical drives, and hard disk drives. In hard disk drives, for example, the width of a data track written to the surface of a disk has decreased due in part to advances in read/write head technology, as well as in reading, writing, and positioning technologies. More narrow data tracks result in higher density hard disk drives. As the density of hard disk drives has increased, manufacturers have sought ways to reduce radial density by optimizing disk surface layout.

A hard disk drive typically includes a disk clamped to a rotating spindle, at least one head for reading data from and/or writing data to the surfaces of each disk, and an actuator utilizing linear or rotary motion for positioning the head over selected data tracks on the disk. A rotary actuator couples a slider on which a head is attached or integrally formed to a pivot point that allows the head to sweep across a surface of a rotating disk. A servo system uses positioning data written in servo wedges and read by the head from the disk to determine the position of the head on the disk. In common servo schemes, positioning data can be included in servo wedges written to the disk surface. In some servo schemes, portions of the servo wedges comprise unused space where bursts within servo bursts patterns are not needed for head positioning.

### BRIEF DESCRIPTION OF THE DRAWINGS

Further details of embodiments of the present invention are explained with the help of the attached drawings in which:

FIG. 1 is an exploded view of an exemplary hard disk drive for applying methods in accordance with embodiments of the present invention.

FIG. 2 is a control schematic for the exemplary hard disk drive of FIG. 1.

FIG. 3 is a diagram showing an example of a data and servo format for a disk in the hard disk drive of FIGS. 1 and 2.

FIG. 4 is a partial detailed view of a servo wedge on the disk of FIG. 3 showing a four-burst pattern.

FIG. 5a illustrates a head positioned near a servo burst, the head having a read element and a write element having circumferential and radial centerlines offset relative to one another.

FIG. 5b illustrates the head of FIG. 5a positioned near an ID and having head skew.

FIG. 5c shows the head of FIGS. 5a and 5b positioned over a four-burst pattern.

FIG. 6 is a partial detailed view of a servo wedge having a four-burst pattern encoded with non-servo information in accordance with an embodiment of the present invention.

FIG. 7 is a partial detailed view of a servo wedge having a four-burst pattern encoded with non-servo information in accordance with an alternative embodiment of the present invention.

### DETAILED DESCRIPTION

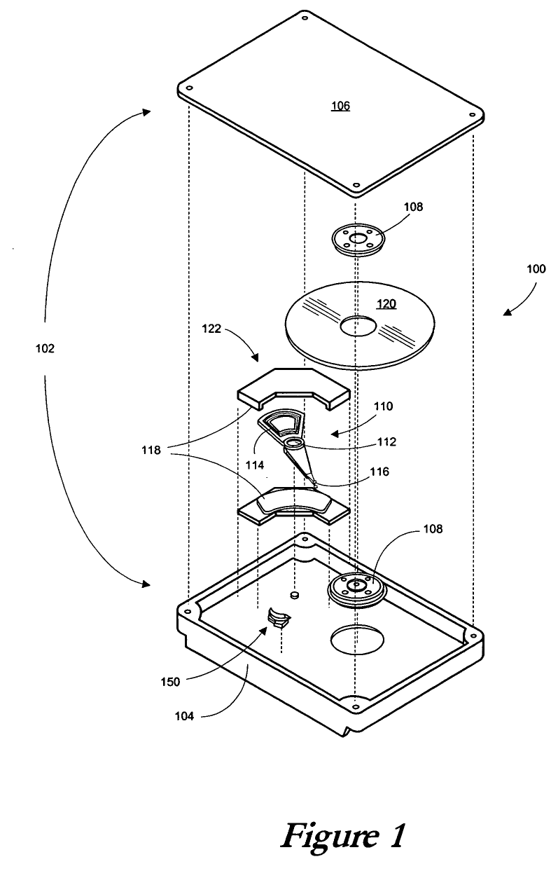

FIG. 1 is an exploded view of an exemplary hard disk drive 100 for applying a method in accordance with an embodiment of the present invention. The hard disk drive 100 includes a housing 102 comprising a housing base 104 and a housing cover 106. The housing base 104 as illustrated is a base casting, but in other embodiments a housing base 104 can comprise separate components assembled prior to, or during assembly of the hard disk drive 100. A disk 120 is attached to a rotatable spindle motor 108, for example by clamping, and the spindle motor 108 is connected with the housing base 104. The disk 120 can be made of a light aluminum alloy, ceramic/glass or other suitable substrate, with magnetizable material deposited on one or both sides of the disk. The magnetic layer has tiny domains of magnetization for storing data transferred through heads 116. In an embodiment, each head 116 is a magnetic transducer adapted to read data from and write data to the disk 120. The disk can be rotated at a constant or varying rate typically ranging from less than 3,600 to more than 15,000 RPM (speeds of 4,200 and 5,400 RPM are common in hard disk drives designed for mobile devices such as laptop computers). The invention described herein is equally applicable to technologies using other media, as for example, optical media. Further, the invention described herein is equally applicable to devices having any number of disks attached to the hub of the spindle motor. In other embodiments, the head 116 includes a separate read element and write element. For example, the separate read element can be a magneto-resistive (MR) head and the write element can be an inductive head. It will be understood that multiple head 116 configurations can be used. Each side of a disk 120 can have an associated head 116, and the heads 116 are collectively coupled to a rotary actuator 110 such that the heads 116 pivot in unison. The invention described herein is equally applicable to devices wherein the individual heads separately move some small distance relative to the actuator. This technology is referred to as dual-stage actuation (DSA).

The rotary actuator 110 is pivotally mounted to the housing base 104 by a bearing 112 and sweeps an arc between an inner diameter (ID) of the disk and a ramp 150 positioned near an outer diameter (OD) of the disk 120. Attached to the housing 104 are upper and lower magnet return plates 118 and at least one magnet that together form the stationary portion of a voice coil motor (VCM) 122. A voice coil 114 is mounted to the rotary actuator 110 and positioned in an air gap of the VCM 122. The rotary actuator 110 pivots about the bearing 112 when current is passed through the voice coil 114 and pivots in an opposite direction when the current is reversed, allowing for precise positioning of the head 116 along the radius of the disk 120. The VCM 122 is coupled with a servo system that uses positioning data read by the head 116 from the disk 120 to determine the position of the head 116 over tracks on the disk 120. The servo system determines an appropriate current to drive through the voice coil 114, and drives the current through the voice coil 114 using a current driver and associated circuitry.

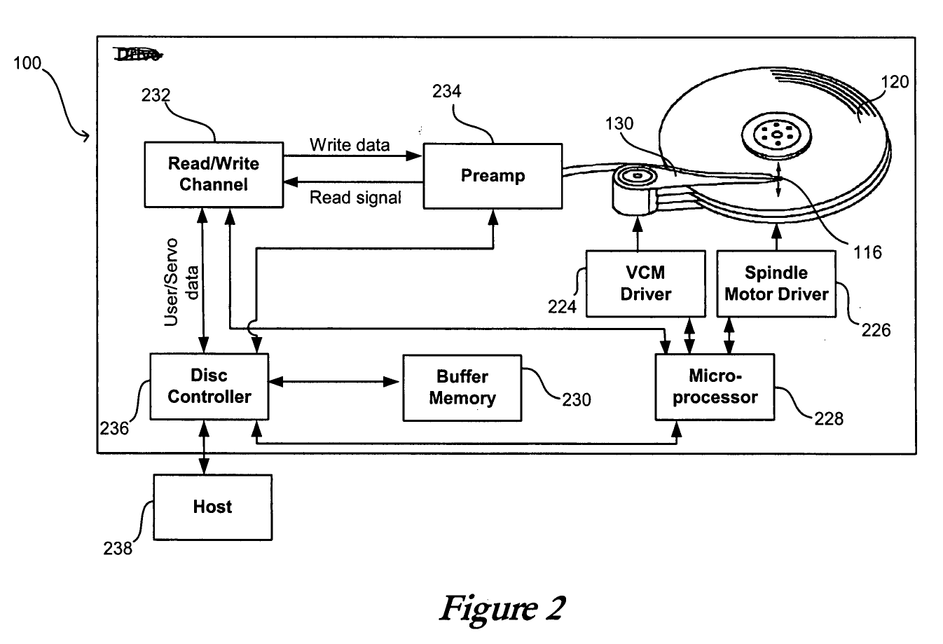

FIG. 2 is a control schematic for the exemplary hard disk drive 100. A servo system for positioning the head 116 can comprise a microprocessor 228 and a servo controller which can exist as circuitry within the hard disk drive 100 or as an algorithm resident in the microprocessor 228, or as a combination thereof. In other embodiments, an independent servo controller can be used. The servo system uses positioning data read by the head 116 from the disk 120 to determine the position of the head 116 over tracks on the disk 120. When the servo system receives a command to position a head 116 over a track, the servo system determines an appropriate current to drive and commands a VCM driver 224 electrically connected with the voice coil 114 to drive the current through the voice coil 114. The servo system can further include a spindle motor driver 226 to drive current through the spindle motor 108 and rotate the disk(s) 120, and a disk controller 236 for receiving information from a host 238 and for controlling multiple disk functions. The host 238 can be any device, apparatus, or system capable of utilizing the hard disk drive 100, such as a personal computer, a Web server or a consumer electronics appliance. An interface controller can be included for communicating with the host 238, or the interface controller can be included in the disk controller 236. In other embodiments, the servo controller, VCM driver 224, and spindle motor driver 226 can be integrated into a single application specific integrated circuit (ASIC). One of ordinary skill in the art can appreciate the different means for controlling the spindle motor 108 and the VCM 122.

The disk controller 236 provides user data to a read/write channel 232, which sends signals to a current amplifier or preamplifier 234. The current amplifier or preamp 234 is electrically connected with the head 116 via a flex circuit (not shown), and sends a signal to the head 116 which is written to the disk(s) 120. The disk controller 236 can also send servo signals to the microprocessor 228. The disk controller 236 can include a memory controller for interfacing with buffer memory 230. In an embodiment, the buffer memory 246 can be dynamic random access memory (DRAM). The microprocessor 228 can include integrated memory or the microprocessor 228 can be electrically connected with external memory (for example, static random access memory (SRAM) 240 or alternatively DRAM).

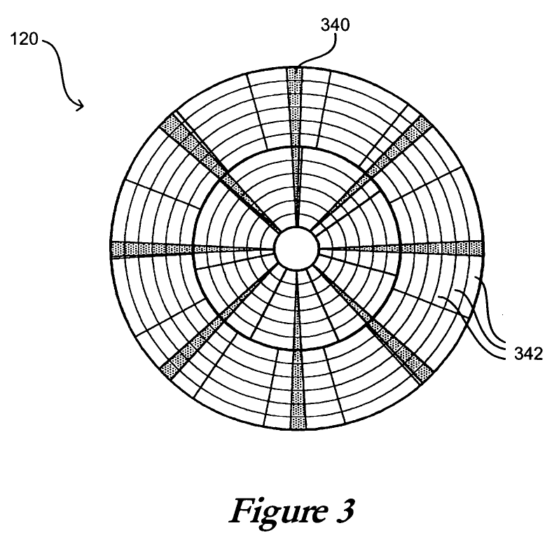

Information stored on the disk 120 can be written in concentric tracks, extending from near the ID to near the OD, as shown in the example disk of FIG. 3. One type of servo system is a sectored, or embedded, servo system in which tracks contain small segments of servo information written in servo wedges 340 or servo sectors preceding corresponding user data sectors. Each track 342 can contain an equal number of servo wedges 340, spaced relatively evenly around the circumference of the track 342. Hard disk drive designs have been proposed having different numbers of servo wedges on different tracks, and such hard disk drive designs could also benefit from the invention contained herein. In a system where the actuator rotates about a pivot point such as a bearing, the servo wedges need not extend linearly from the ID to the OD, but may be curved slightly in order to adjust for the trajectory of the head as it sweeps across the disk.

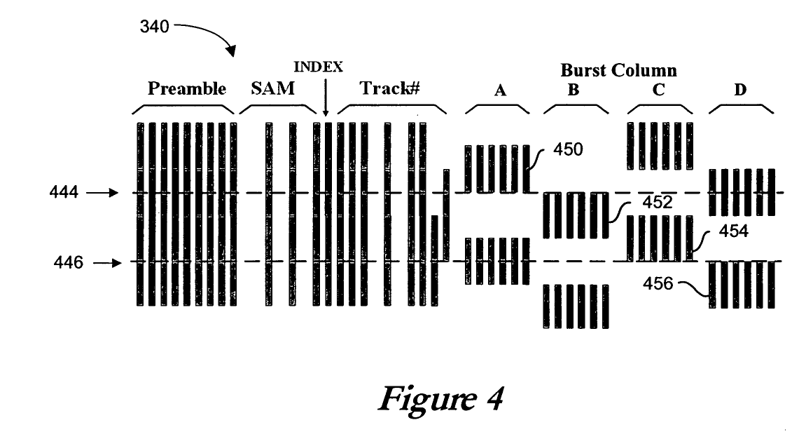

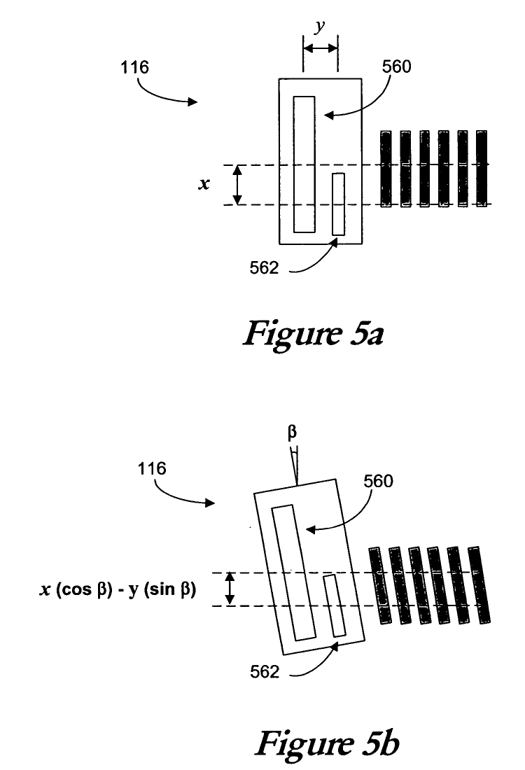

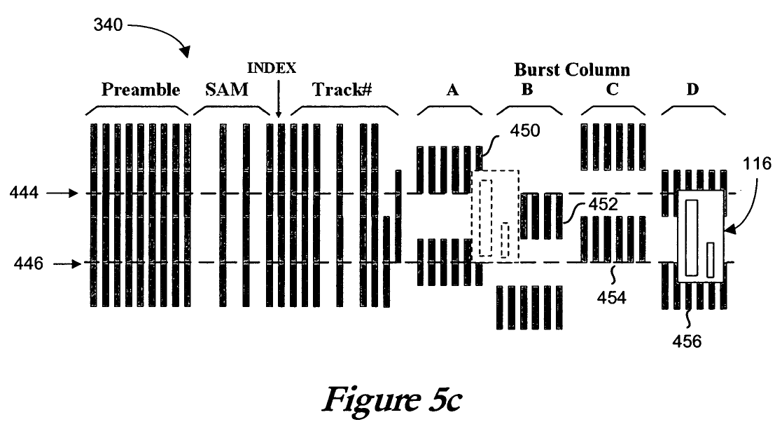

FIG. 4 shows a magnified portion of the surface of the disk 120. This portion can comprise a plurality of servo tracks, extending radially across the disk surface (vertically as illustrated), and can span the width of a single servo wedge 340, circumferentially across the disk surface (horizontally as illustrated). A typical disk surface can include a servo pattern having tens of thousands of servo tracks, each having hundreds of servo wedges. In FIGS. 4 and 5, the patterned areas indicate portions of the disk surface that have been magnetized in one direction. Areas without patterning have been magnetized in another direction, typically in a direction opposite to that of the patterned areas. For a hard disk drive 100 that uses longitudinal recording, the two directions can be in the positive and negative circumferential directions. For a hard disk drive 100 that uses vertical recording technology (also sometimes referred to in the industry as “perpendicular recording”) the two directions can be perpendicular to the recording surface, such as would be “in” and “out” of the page for the illustration of FIG. 4. The simplified figure does not show effects of side writing of the write element, which can produce non-longitudinal magnetization and erase bands. Such effects are not of primary importance to the discussion herein.

The exemplary servo pattern contains in succession a preamble, a servo-address mark (SAM), an INDEX-bit, and a track number, as is known in the art. Other information can be written to the servo pattern in addition to, or in place of, the information shown in FIG. 4. An INDEX-bit, for example, can be used to determine circumferential position by giving the servo system an indication of which wedge is wedge number zero. It is possible that the servo wedge might contain a wedge-number in place of (or in addition to) the index bit, as would be apparent to one of skill in the art. The track number, which can be a gray coded track-number, can be used by the servo system to determine the coarse radial position of the head. Following the track number, the head writes one of four positioning bursts (referred to herein interchangeably as “servo bursts” and “bursts”) which can later be used by the servo system to determine the fine radial position of the head relative to the track centerline (i.e. a fractional track). The radial width of the written servo track can be determined by the magnetic write-width of the write element of the servowriting head, for example where untrimmed bursts are used, or the width of the servo track can be less than the magnetic write-width of the write element of the servowriting head, for example where trimmed are used in a so-called “three-servowriting-step-per-track” servo format (also commonly referred to in the industry as a “three-pass-per-track” servo format), or the width of the servo track can be greater than the magnetic write width of the head, for example, where a trimmed, stitched-burst pattern is used. The number of servo bursts used and the relative arrangement of the servo bursts can vary with servo pattern.

Servo information can be positioned regularly about each track, such that when a read element of the head reads the servo information, a relative position of the head can be determined that can be used by a servo processor to adjust the position of the head relative to the track. For each servo wedge 340, this relative position can be determined in one example as a function of the target location, a track number read from the servo wedge, and the amplitudes and/or phases of the bursts, or a subset of the bursts. The measure of the position of the read element of the head relative to the centerline of a target track will be referred to herein as a “position-error signal” (PES). The centerline for the target data track can be defined relative to a series of bursts, burst edges, or burst boundaries. For example, as shown in FIG. 4 a first track centerline 444 is defined by a lower edge of a burst from column A (an “A-burst”) 450 and an upper edge of a burst from column B (a “B-burst”) 452. The centerline can also be defined by, or offset relative to, any function or combination of bursts or burst patterns. This can include, for example, a location at which the PES value is a maximum, a minimum, or a fraction or percentage thereof. Any location relative to a function of the bursts can be selected to define track position. For example, if a read head evenly straddles an A-burst 450 and a B-burst 452, or portions thereof, then servo demodulation circuitry in communication with the head can produce equal amplitude measurements for the two bursts, because the portion of the signal coming from the A-burst 450 above the centerline is approximately equal in amplitude to the portion coming from the B-burst 452 below the centerline 444. The resulting computed PES can be zero if the radial location defined by the A-burst/B-burst (A/B) combination, or A/B boundary, is a track centerline. In an embodiment, the radial location at which the PES value is zero can be referred to as a null-point. Null-points can be used in each servo wedge to define a relative position of a track. If the head is too far towards the OD (above the centerline in the figure) then there will be a greater contribution from the A-burst 450 that results in a non-zero PES value, such as a “negative” PES. Using the negative PES, the servo controller can direct the VCM to move the head toward the ID and closer to the head's desired position relative to the centerline. This can be done for each set of burst edges defining the centerline of that track.

The PES scheme described above is one of many possible schemes for combining the track number read from a servo wedge and the phases or amplitudes of the servo bursts. As shown, the PES scheme of FIG. 4 includes bursts arranged in a three-servowriting-step-per-track pattern. A ratio of radial density of servo tracks (defined by the radial width of the servo bursts) to a radial density of data tracks is 3:2. In other embodiments, the ratio of the radial density of servo tracks to the radial density of data tracks can be greater or less than as shown in FIG. 4; for example, a two-servowriting-step-per-track pattern can be used. Further, the PES scheme can include any number of columns of servo bursts arranged sufficient to define a fractional position of the head relative to the track centerline. For example, in an alternative embodiment the PES scheme can include a six-burst pattern rather than the four-burst pattern illustrated in FIG. 4. Many other schemes are possible that can benefit from embodiments in accordance with the present invention.

In the PES scheme shown in FIG. 4, the centerline for each track is defined by burst edges of bursts from two columns. The centerlines for radially adjacent tracks are defined by burst edges of bursts from two other columns. Thus, a first track centerline 444 is defined by the lower edge from the A-burst 450 and the upper edge from the B-burst 452 and a second track centerline 446 for a second track adjacent to the first track can be defined by a lower edge from a burst from column C (a “C-burst”) 454 and an upper edge from a burst from column D (a “D-burst”) 456. As can be seen, each track centerline passes through two burst columns that are not used to define the track centerline. Extended circumferentially, the first track centerline 444 passes between C-bursts in column C and through a D-burst in column D. In many PES schemes, portions of bursts-columns that are not needed to identify a centerline of a given track may not be needed to servo along the centerline of that track.

A portion of the servo pattern which identifies or precedes data tracks in which user data is stored may or may not use bursts from each column, depending on a position along the stroke and a write-to-read offset between the write element and the read element of the head. For example, as shown in FIG. 5a, the head 116 can include a wide write element 560 and a narrow read element 562, each having radial centerlines offset from one another by some small distance x. The narrow width of the read element 562 relative to a track allows the head 116 to read the track even if the head 116 is not precisely following a track centerline, thus increasing track following tolerance of the servo system. The wide write element 560 and the narrow read element 562 can also have circumferential centerlines offset from one another by some small distance y. The relative positions of the read and write elements can vary with manufacturing tolerances, but in a typical head arrangement some small distance exists between the read and write elements. The small distance can further vary across the stroke with head skew. As shown in FIG. 5b, a skew of the head relative to the track varies across the stroke as the head sweeps an arc with a pivot of the rotary actuator, causing the offset between the read element 562 and the write element 560 to vary despite the fixed relative position of the read and write elements. Thus, where the head skew at a location near the ID is an angle β, the write-to-read offset can be x(cos β)−y(sin β) where no other factors contribute to variation in the radial distance between the read and write elements. Thus, burst transitions from bursts in columns not used when positioning the head relative to the track center while writing data may be needed for off-track placement when reading data. In the four-burst track following scheme described above, the head 116 can be positioned at a track center when writing data, but when reading, the position of the head relative to the track must be adjusted by the write-to-read offset. For example, for the head 116 following the second track centerline 446 in FIG. 5c, the offset can reposition the head such that the read element measures relative amplitudes from the A-bursts 450,451 and the B-burst 452 positioned above the second track centerline 446 defined by the C-burst 454 and D-burst 456.

A portion of the servo pattern that does not identify or precede data tracks in which user data is stored need only rely on the data track centerlines as defined during the write step. For the four-burst scheme of FIG. 4, each track centerline 444,446 is defined by two columns, leaving two columns unused. The portions of two burst-columns occupy unused space within the servo wedge. The circumferential width of the portion of unused space can increase for PES schemes that use a larger number of burst-columns (e.g., where a six-burst PES scheme is used). Such a portion of the servo pattern can be located near the OD, for example between the first user track and an acquire track, near the ID, for example between the final user track and an inner crash stop, or in a location along the disk surface otherwise not used for storing user data.

Systems and methods in accordance with the present invention can comprise servo patterns having identifiable bursts for encoding non-servo information. A method in accordance with an embodiment of the present invention can include incorporating information into a servo pattern in a portion of the servo pattern that is not used to identify the position of a head on a surface of the disk. For example, in an embodiment the unused portion can contain a digital (binary) string of bits recording information identifying the hard disk drive serial number, identifying a date of manufacture of the hard disk drive, providing component information of the disk, etc. Such a binary string is described in U.S. Pat. No. 6,049,438 to Serrano et al, the binary string being incorporated into a phase burst defining a track centerline. The information recorded can be unique or non-unique. One of ordinary skill in the art can appreciate the myriad different information that can be recorded as a binary string of bits. In other embodiments the burst need not comprise a portion of a binary string, for example the burst can comprise a discrete bit.

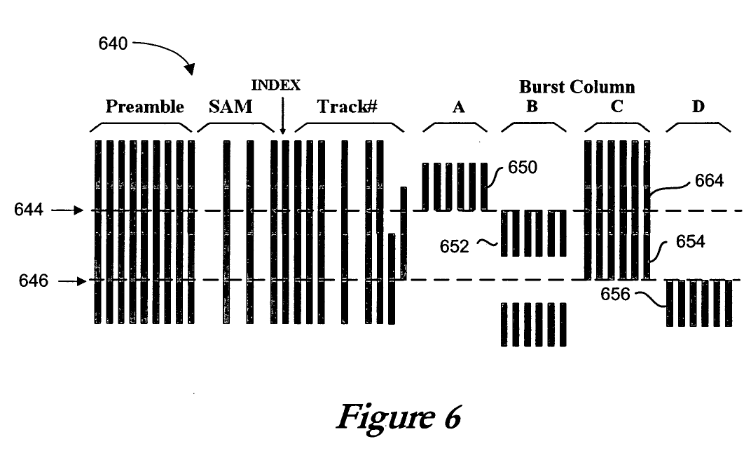

In an embodiment, a servo pattern can include a binary string comprising a presence or absence of one or more servo bursts in one or more burst columns of one or more servo wedges. For example, FIG. 6 illustrates a PES scheme using a four-burst pattern having a first track centerline 644 defined by a lower edge of an A-burst 650 and an upper edge of a B-burst 652, and a second track centerline 646 defined by a lower edge of a C-burst 654 and the upper edge of a D-burst 656. The first track centerline 644, extended through column C and column D, passes through a burst 664 in column C which is not present in the repeating burst pattern, but a burst which is present in column D of the repeating burst pattern is absent. Further, the second track centerline 646, extended through column A and column B, does not pass through a burst in column A which is present in the repeating servo pattern. A bit can be set where a column deviates from the repeating burst pattern. A bit can be clear where a column conforms to the repeating burst pattern. Thus, in the servo pattern illustrated in FIG. 6, the servo system interprets a “11” as the read element following the first track centerline 644 reads a C-burst 664 in column C and does not read a D-burst in column D. When the head passes over the adjacent track, the servo system interprets a “10” as the read element following the second track centerline 646 does not read an A-burst in column A and does not read a B-burst in column B. Digital bits from one or more servo wedges and/or one or more tracks (consecutive or not) can be strung together in any given order to form a binary string. The binary string can be interpreted as information (e.g., a serial number, a date of manufacture). In other embodiments, it is possible that only a single column will deviate from the normal pattern in any one wedge.

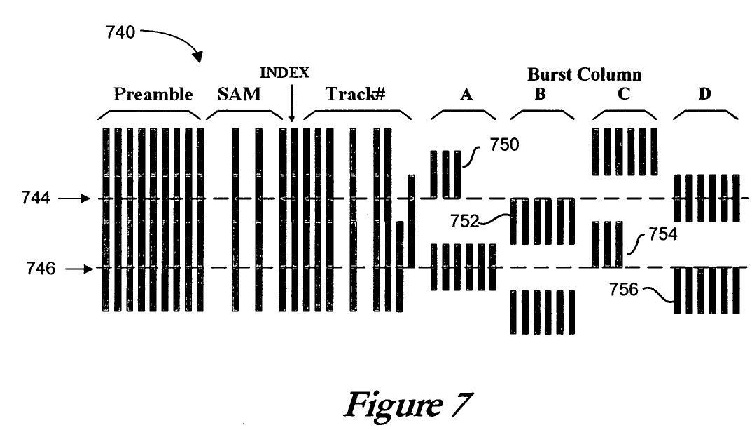

In other embodiments in accordance with the present invention, a method can include incorporating burst patterns having identifiable bursts that are usable in track following. For example, demodulation circuitry can be used to demodulate each burst as two distinct halves so that, for example, four bursts from four different columns can be interpreted effectively as eight bursts. A first half of the burst can be used to calculate a PES while the second half of the burst can contain digital information, or vice versa. A burst pattern taking advantage of such demodulation is illustrated in FIG. 7, which shows a four-burst pattern similar to the four-burst pattern of FIGS. 4 and 5c wherein an A-burst 750 partially defining a first track centerline 744 includes a first half with transitions and a second half without transitions, such that only the first half of the A-burst 750 is effectively present. Similarly, a C-burst 754 partially defining a second track centerline 746 include a first half with transitions and a second half without transitions. A bit can be set where a second half of a burst includes transitions (i.e. the second half of the burst is present), or clear where the second half of a burst lacks transitions (i.e. the second half of the burst is absent). In other embodiments, the logic can be reversed such that a bit is set with an absence of a burst and clear with a presence of a burst.

The burst pattern can be arranged so that bursts from any combination of columns can comprise a portion of the binary string. For example, in the pattern of FIG. 7, where bursts from column A and column C only are interpreted as comprising portions of the binary string, the servo system interprets a “0” as the read element following the first track centerline 744 does not read a second half of an A-burst 750 in column A. When the head passes over the adjacent track, the servo system interprets a “0” as the read element following the second track centerline 746 does not read a second half of a C-burst 754 in column C. In other embodiments, bursts from two columns on each track can be interpreted as comprising portions of the binary string, such that the servo system interprets “01” as the read element passes over the first track centerline 744 (detecting the absence of the second half of the A-burst, but the presence of the second half of the B-burst) and “01” again as the read element passes over the second centerline 746 (detecting the absence of the second half of the C-burst, but the presence of the second half of the D-burst). One of ordinary skill in the arts can appreciate the different ways in which binary strings can be encoded. As above, digital bits from one or more servo wedges and/or one or more tracks (consecutive or not) can be strung together in any given order to form a binary string. The binary string can be interpreted as information (e.g., a serial number, a date of manufacture). Because demodulating each burst from a burst-column as two separate bursts allows for PES calculation, and thus track following, such a burst pattern can be incorporated into portions of servo wedges preceding data tracks.

Systems in accordance with the present invention can comprise a data storage device with at least one medium having a surface incorporating a servo pattern including a burst pattern encoding non-servo information, as described above. Burst patterns in accordance with embodiments wherein bursts in unused columns are written or removed can be incorporated into the servo pattern and located near the OD or near the ID where user data are not stored, or alternatively such burst patterns can be incorporated into any portion of the servo pattern wherein columns within the burst pattern are unused. For example, a manufacturer can choose to dedicate space (i.e. wedges) on the disk surface to encode the binary string where the dedicated space is otherwise usable for user data. The dedicated space may not be suitable for storing user data where a write-to-read offset exists. Burst patterns in accordance with alternative embodiments wherein bursts are individually demodulated as two or more separate bursts can be incorporated into portions of servo wedges preceding data tracks. Because only a portion of the possibly affected bursts can be used for position demodulation purposes in these tracks, the demodulated PES will likely be noisier, as the shortened bursts will present a lower signal-to-noise ratio than full bursts. This is probably acceptable on tracks that do not contain user data.

In an embodiment, a system can include an algorithm resident within the servo system, for example resident in the microprocessor or disk controller, for interpreting the binary string as information. In other embodiments, the system can include read-only memory (ROM) or other medium associated with the servo system to store firmware for identifying and/or interpreting the binary string. ROM used to store the firmware can be programmable read-only memory (PROM), or electrically erasable programmable read-only memory (EEPROM), etc, or alternatively, the firmware can be stored on a medium other than ROM, for example FLASH memory. In other embodiments the servo system can include an algorithm for identifying a binary string, which is sent to an external source, for example to a host, which interprets the binary string.

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalence.

1. A burst pattern for positioning a head on a reference surface of a rotatable medium for use in a data storage device, comprising:
a plurality of servo bursts arranged in a plurality of burst columns of a servo wedge;
a track centerline defined by a servo burst from two or more of the plurality of burst columns;
wherein at least one of the burst columns is not used to define the track centerline; and
wherein the at least one burst column includes a servo burst representing non-servo information.

2. The burst pattern of claim 1, wherein the servo bursts that define corresponding track centerlines are arranged in a repeating pattern.

3. The burst pattern of claim 2, wherein the non-servo information is a “1” if the portion of the non-servo information does not conform to the repeating pattern; and
wherein the non-servo information is a “0” if the non-servo information conforms to the repeating pattern.

4. The burst pattern of claim 1, wherein the non-servo information is a portion of a binary string.

5. The burst pattern of claim 1, wherein the non-servo information is a unique identifier.

6. The burst pattern of claim 1, wherein the non-servo information represents characterizing information.

7. The burst pattern of claim 1, wherein the non-servo information represents at least one of a serial number, a manufacturing date, and component information.

8. A burst pattern for positioning a head on a reference surface of a rotatable medium for use in a data storage device, comprising:
a plurality of servo bursts arranged in a plurality of burst columns of a servo wedge;
wherein a servo burst from two or more of the burst columns is arranged to produce a position error signal when read by the head;
wherein at least one burst column is not used to define the track centerline; and
wherein a servo burst from said at least burst column includes non-servo information.

9. The burst pattern of claim 8, wherein the non-servo information is a portion of a binary string.

10. The burst pattern of claim 8, wherein said servo burst from two or more of the burst columns arranged to produce a position error signal when read by said head is arranged in a repeating pattern.

11. The burst pattern of claim 10, wherein the non-servo information is a “1” if the non-servo information does not conform to the repeating pattern; and
wherein the portion of the binary string is a “0” if the non-servo information conforms to the repeating pattern.

12. The burst pattern of claim 8, wherein the non-servo information is a unique identifier.

13. The burst pattern of claim 8, wherein the non-servo information represents characterizing information.

14. The burst pattern of claim 8, wherein the non-servo information represents at least one of a serial number, a manufacturing date, and component information.

15. The burst pattern of claim 8, wherein:
said servo burst from two or more of the burst columns includes a first half and a second half;
one of the first half and the second half is arranged to produce a position error signal when read by said head; and
the other of the first half and the second half is non-servo information.

16. The burst pattern of claim 15, wherein said servo burst from two or more of the burst columns is arranged in a repeating pattern.

17. The burst pattern of claim 16, wherein the non-servo information is a “1” if the non-servo information does not conform to the repeating pattern; and
wherein the non-servo information is a “0” if the non-servo information conforms to the repeating pattern.

18. A method to encode information in a servo pattern on a rotatable medium in a data storage device having a head to access the rotatable medium, comprising:
selecting a rotatable medium;
writing a servo pattern on at least one surface of the rotatable medium to determine a position of the head along the at least one surface, the servo pattern including one or more servo wedges, each servo wedge having a burst pattern to calculate a position error signal when the burst pattern is read by the head, the burst pattern including a plurality of burst columns;
defining a track centerline within the burst pattern using two or more of the burst columns; and
encoding non-servo information in one or more of the burst columns not defining the track centerline.

19. The method of claim 18, wherein the track centerline is defined by a plurality of servo bursts arranged in conformance with a repeating pattern within the two or more burst columns.

20. The method of claim 19, wherein the non-servo information is a “1” if the non-servo information does not conform to the repeating pattern; and
wherein the non-servo information is a “0” if the non-servo information conforms to the repeating pattern.

21. The method of claim 18, wherein in the encoding step the non-servo information is a binary string including one or more portions from one or more servo wedges.

22. The method of claim 21, wherein in the encoding step the non-servo information represents characterizing information.

23. The method of claim 21, wherein in the encoding step the non-servo information represents at least one of a serial number, a manufacturing date, and component information.
